(19) United States
(12) Patent Application Publication
(10) Pub. No.: US 2008/0165655 A1
(43) Pub. Date: Jul. 10, 2008

(54) Optical pickup device

(76) Inventors: Ryo Saitoh, Kanagawa-ken (JP); Makoto Itonaga, Kanagawa-ken (JP)

Correspondence Address: THE NATH LAW GROUP, 112 South West Street, Alexandria, VA, 22314, US

(21) Appl. No.: 12/007,141

(22) Filed: Jan. 7, 2008

(30) Foreign Application Priority Data
Jan. 9, 2007 (JP) 2007-001074
Jan. 9, 2007 (JP) 2007-001075
Jul. 4, 2007 (JP) 2007-176008

(51) Int. Cl. G11B 7/00

(52) U.S. Cl. 369/109.01

(57) ABSTRACT

First order diffraction lights reflected on a first signal face for reproducing an optical disc and further deflected by a spatial divide element converge to spots 21a to 21d on photo acceptance cells 9A to 9D of a photodetector 9, while diffraction lights reflected on the first signal face and further diffracted by other orders of diffraction except plus first-order and diffraction lights reflected on a second signal face become crosstalk lights. Therefore, an optical pickup device is adapted so that minus (−) first-order diffraction lights 23a to 23d from the first signal face and the spots 21a to 21d of the first order diffraction light from the second signal face are not radiated on the photo acceptance cells 9A to 9D.

### BACKGROUND OF THE INVENTION

1. Field of the Invention

The present invention relates to an optical pickup device which includes an element having a plurality of areas between an objective lens and a photodetector and which allows recording or reproducing against not only an optical disc having a signal face in a single layer but also an optical disc having signal faces in multiple layers.

2. Description of Related Art

As the disc-shaped optical recording medium, an optical disc is formed with spiral or concentric tracks on a transparent substrate. The optical disc is widely used as a general recording medium since it allows a high-density recording of information, such as image information, audio information and computer data and a high-speed access to a desired track in reproducing the recorded tracks.

As for this kind of optical disc, CD (Compact Disc) and DVD (Digital versatile Disc) have been already available commercially. In view of progressing high density, there are recently, distributed two kinds of high-density and mass-storage recording mediums, that is, BD (Blu-ray Disc) and HD-DVD (High Definition DVD).

For mass storage optical discs, development of a multilayer optical disc having respective signal faces in multiple layers (simply referred to as “multilayer optical disc” after) and its standardization have been developed. In DVD-ROM and DVD-R, optical discs each having one side with double layer signal faces (referred to as “single-sided double layer optical disc” after) have been already available to the market, while the standardization for single-sided double layer optical discs is in progress in DVD-RW, BD and HD-DVD. Additionally, the development of 4-layer optical disc and 8-layer optical disc for BD has been recently published in the academic community.

Meanwhile, an optical pickup device for reproducing the above-mentioned single-sides double layer optical disc of DVD is adapted so as to detect a tracking error signal called “DPD signal” by using a DPD (Differential Phase Detection) method using one beam. In the DPD method, the DPD signal is picked up based on a phase-contrast between optical strength modulation signals obtained by receiving returning lights reflected on the signal face of an optical disc (referred to as “reflection lights” after). In case of the recording type optical disc, such as DVD-R and DVD-RW, however, it is impossible to detect the DPD signal before recording signals, although it can be detected after recording signals. Hence, for the recording type optical disc of DVD, a DPP (Differential Push Pull) method using three beams is being employed to detect a tracking error signal called “DPP signal”. In the DPP method, a tracking error signal with no offsetting is obtained by detecting differentials between a push-pull signal of a main beam and push-pull signals of sub-beams on both sides of the main beam.

In HD-DVD to be recorded and reproduced with use of a blue laser source of about 405 nm in wavelength, for the recording type optical disc and the reproducing type optical disc, the tracking detection error signals are detected by the similar method to above DVD. On the other hand, in BD of a different standard to be recorded and reproduced with use of the blue laser source of about 405 nm in wavelength, the detection of the DPD signal after recording signals to a recording type optical disc is unassured by the standard, although the DPD signal can be detected in BD-ROM. For that reason, it is general to detect the DPP signal in both the recording type optical disc and the reproducing type optical disc.

Here, the application of the DPP method to a single-sided double layer optical raises a problem as follows. That is, unnecessary crosstalk light, which is a reflection light from a signal face in the other layer in unrecorded or non-reproduced state, namely, a defocussing layer (referred to as “other layer” after), enters the photodetector to produce coherent noise due to the overlapping with a reflection light from a signal face in a layer on recording or reproducing (referred to as “recording-reproducing layer” after). The behavior of coherent noise is determined by a difference in optical path between two interfering lights, an optical-path difference due to a layer-to-layer interval. Furthermore, the behavior of coherent noise is also influenced by a variance in the layer-to-layer interval depending on the track position of an optical disc, its tilted condition and a track (groove) for recording during playback.

In case of the DPP signal, the amount of light from each sub-beam is established smaller than that of the main beam in order to prevent a false recording by the sub-beams at recording and further use the light effectively. Therefore, the sub-beams are subjected to a significant influence of the crosstalk lights in comparison with the main beam, causing the above problem remarkably.

The influence of crosstalk lights arises in case of a single-sided double layer optical disc of DVD, too. However, it is reported that more stable recording and reproducing cannot be attained in case of BD rather than DVD (nonpatent document No. 1: Alexander van der Lee, et. al., “Drive consideration for multilayer discs”, ISOMO6, Technical Digest, P30, Mo—C-5). The reasons are as follows. First, comparing with DVD, each spot size of the crosstalk lights is enlarged since the layer-to-layer interval is narrowed to reduce a difference in optical path and the number of openings (NA) of the objective lens is elevated. Secondly, the blue laser source having a wavelength of 405 nm accelerates lasers' coherency.

In such a situation, there is proposed a detection method of the tracking error signal adopting the one-beam type APP (Advanced Push Pull) method (nonpatent document No. 2: Kousei SANO, et. al., “Novel One-Beam Tracking Detection Method for Dual-Layer Blu-ray Discs”, Japanese Journal of Applied Physics, Vol. 45, No. 2B, 2006, pp. 1174-1177 (FIGS. 4, 6 and 7)).

FIG. 1 is a structural view of a detection system of an optical pickup device disclosed in nonpatent document No. 2 by way of example. FIG. 2 is a view showing HOE pattern (far field pattern) used in the detection system of the optical pickup device disclosed in the nonpatent document No. 2 by way of example. FIG. 3 is a view showing spread of crosstalk light of a conventional optical pickup device disclosed in the nonpatent document No. 2 by way of example.

Referring to FIGS. 1 to 3, the operation of the conventional optical pickup device whose PD (photodetector) receives reflection light from an optical disc will be described below. In FIG. 1, a focussing-error signal is detected as follows. The reflection light from a signal face of the optical disc is transmitted through a hologram optical element (referred to as “HOE” after) 201 without being subjected to diffraction and further changed to be convergent light by a lens 202. Then, the convergent light is transmitted with astigmatism through a cylindrical lens 203 and further received by a focusing PD 204.

On the other hand, a tracking-error signal is detected as follows. The reflection light from the signal face of the optical disc is diffracted by the HOE 201 and further changed to be convergent light by the lens 202. Astigmatism applied by the HOE 201 is cancelled by the cylindrical lens 203. Then, the convergent light is received by a tracking PD 205 (205A to 205D).

FIG. 2 shows a pattern of the HOE 201. The HOE 201 is divided into five areas 201A to 201E. FIG. 3 shows signal detection light spots and crosstalk light spots at the focusing PD 204 and the tracking PD 205. In the reflection light from the signal face of the recording-reproducing layer, light without diffraction effect by the HOE 201 forms a spot 206 at the photo acceptance part 204 into a signal detection light for detecting the focussing-error signal.

In the reflection light from the signal face of the recording-reproducing layer, light diffracted in the area 201A forms a spot 207A on the PD 205A, light diffracted in the area 201B a spot 207B on the PD 205B, light diffracted in the area 201C a spot 207C on the PD 205C, and light diffracted in the area 201D forms a spot 207D on the PD 205D, providing signal detection lights for detecting the tracking signal, respectively. In the reflection light from the signal face of the recording-reproducing layer, light diffracted in the area 201E forms a spot 207E, although it is not radiated on the focusing PD 204 and the tracking PD 205.

Next, we explain crosstalk lights from the signal face of the other layer. A spot 208 by the crosstalk light reflected on the signal face of the other layer and further subjected to no diffraction by the HOE 201 is not radiated on the tracking PD 205, although the spot is radiated on the focussing PD 204. The crosstalk light reflected on the signal face of the other layer and further diffracted by the area 201B forms a spot 209A, the crosstalk light diffracted by the area 201B a spot 209B, the crosstalk light diffracted by the area 201C a spot 209C, and the crosstalk light diffracted by the area 201D forms a spot 209D, respectively. However, these spots are not radiated on the tracking PD 205 since they are positioned in the circumference of the tracking PD 205.

The crosstalk light diffracted by the area 201E forms spots 209E that are positioned on left and right of the focussing PD 204 and not radiated on the tracking PD 205. Assuming that “TA” represents an electrical signal obtained by the PD 205A, “TB” an electrical signal obtained by the PD 205B, “TC” an electrical signal obtained by the PD 205C and “TD” represents an electrical signal obtained by the PD 205D, the tracking error signal TAPP is calculated by the following equation (1) in accordance with the APP method:

TAPP=TC−TD−Tk·(TA−TB) (1),

where Tk is a constant number.

As another method of solving the problems of the crosstalk lights, there is proposed an one-beam detection method of the tracking error signal in accordance with the PP method, which is similar to nonpatent document No. 2 (nonpatent document No. 3: Noriaki Nishi et al., “Novel One-Beam Detection Method with Changeable Multi Division Patterns”, Proc. of SPIE, Vol. 6282, 62821H-1 (FIGS. 4 and 5)). FIGS. 4A to 4D are structural views showing one example of a liquid crystal element used for a detection system of an optical pickup device described in the nonpatent document No. 3. FIGS. 5A and 5B are views showing the formation of beam spots on photo acceptance cells of the optical pickup device described in the nonpatent document No. 3.

Referring to FIGS. 4A to 4D and FIGS. 5A and 5B, we now describe the operation of detecting the reflection light from the signal face in the optical pickup device described in the nonpatent document No. 3, in brief. As shown in FIG. 4A, the liquid crystal element 210 comprises a triple-layer structure formed by a non-polarizing HOE 211, a liquid crystal active rotator 212 and a polarizing HOE 213, in order from the side of an optical disc (not shown).

As shown in FIG. 4B, the non-polarizing HOE 211 is a diffraction element having a lens effect to detect the focussing error signal, generating first and minus first order diffraction lights. The liquid crystal active rotator 212 is adapted so as to change polarizing directions in accord with turning-on (ON) or turning-off (OFF) in voltage. The polarizing HOE 213 is formed by a recording type pattern 213A of FIG. 4C and a reproducing type pattern 213B of FIG. 4D in lamination.

In order to detect a tracking error signal of recording type, the liquid crystal active rotator 212 is turned off in voltage to change an emission polarizing direction to a direction perpendicular to the incidence polarizing direction. Then, as shown in FIG. 5A, the recording type pattern 213A of the polarizing HOE 213 is effected so as to receive zero, first and minus first order diffraction lights on the PD 214, so that the tracking error signal is detected by means of the APP method similar to the nonpatent document No. 2. In calculation, a center area 213E of the recording type pattern 213A is eliminated from the calculation of the tracking error signal to reduce the influence of the crosstalk lights.

On the other hand, when detecting a tracking error signal of reproducing type, the liquid crystal active rotator 212 is turned on in voltage to make the emission polarizing direction mission coincide with the incidence polarizing direction. Then, as shown in FIG. 5B, the reproducing type pattern 213B of the polarizing HOE 213 is effected so as to receive zero, first and minus first order diffraction lights on the PD 214, so that the tracking error signal is detected by means of the DPP method.

### SUMMARY OF THE INVENTION

The optical pickup device of the nonpatent document No. 2 described with reference to FIGS. 1 to 3 stabilizes the tracking error signal so that the tracking PD 205 is not influenced by crosstalk lights. However, as the detection beam is divided into two routes for the focussing PD 204 and the tracking PD 205 so that the signal from the focussing PD 204 cannot be used to detect the main signal, the signal output is lowered to reduce the S/N ratio in the signal detection. Particularly, if reproducing at a high speed, this problem would become marked.

The optical pickup device of the nonpatent document No. 3 described with reference to FIGS. 4A to 4D and FIGS. 5A and 5B is faced with a problem of high price as a whole due to many expensive components, such as liquid crystal active rotator 212 and the polarizing HOE 213A, HOE213B in double patterns, in spite of the possibility of detecting the recording and reproducing type tracking error signals while reducing the influence of crosstalk lights.

Under the above-mentioned problems, an object of the present invention is to provide an optical pickup device enabling signals stable with improved S/N ratios to be gained at a low cost when recording or reproducing information with respect to a multilayer optical disc.

In order to achieve the above object, there is provided an optical pickup device comprising: a laser source for emitting laser beams; a collimator lens for converting the laser beams emitted from an emission point of the laser source to substantially-parallel lights; an objective lens that converges the substantially-parallel lights to form spots on a first signal face or a second signal face of an optical disc; a spatial divide element having a plurality of parting lines arranged so as to run on a substantial flux center of a reflection light from the first signal face or the second signal face and a plurality of areas defined by the parting lines to thereby diffract the reflection light to predetermined directions respectively; and a photodetector receiving signal detection lights diffracted in the predetermined directions and applied with astigmatisms by the areas of the spatial divide elements and including a plurality of photo acceptance cells arranged in positions where the signal detection lights form a circle of least confusion at a substantial midpoint of two focal lines produced due to the astigmatisms, the photo acceptance cells corresponding to the plurality of areas respectively.

### BRIEF DESCRIPTION OF THE DRAWINGS

FIG. 1 is a view showing a detection system of a conventional optical pickup device;

FIG. 2 is a view showing a HOE pattern (far field pattern) used in the detection system of the conventional optical pickup device;

FIG. 3 is a view showing a condition of spots of signal detection light and crosstalk light of the conventional optical pickup device;

FIGS. 4A to 4D are views showing structures of liquid crystal elements used in the detection system of the conventional optical pickup device;

FIGS. 5A and 5B are views showing a condition that a beam of the conventional optical pickup device is collected to a photo acceptance cell;

FIG. 6 is a view showing one example of an overall structure of an optical pickup device of the present invention;

FIG. 7 is a view showing one example of a detection system in FIG. 6 of the present invention, in detail;

FIG. 8 is a view showing one example of areas of an element face of a spatial divide element of the present invention;

FIG. 9 is a view showing one example of the arrangement of photo acceptance cells corresponding to the areas of the spatial divide element of the present invention;

FIG. 10 is a block diagram showing one example of an arithmetic circuit of signal outputs of the photo acceptance cell of the present invention;

FIG. 11 is a view showing one example of the state of crosstalk lights on an acceptance surface of a photodetector in FIG. 9;

FIG. 12 is a view showing another example of the areas in the element face of the spatial divide element of the present invention;

FIG. 13 is a view showing another example of areas in an element face of a diffractive optical element of the present invention;

FIG. 14 is a view showing one example of the arrangement of the photo acceptance cells corresponding to the areas of the diffractive optical element of the present invention;

FIG. 15 is a view showing effective distances on both emission and detection sides of the optical pickup device of the present invention;

FIGS. 16A to 16C are views showing one example of an S-curve to gain a focussing error signal and spot profiles of the optical pickup device of the present invention;

FIGS. 17A and 17B are views showing spot profiles on a HOE face of the diffractive optical element of the present invention, including overlapping parts between a zero order diffraction light and a first order diffraction light both diffracted by tracks;

FIG. 18 is a view showing an example of the crosstalk lights on the acceptance surface of the photodetector in FIG. 14;

FIG. 19 is a view showing another example of the areas of the element face of the diffractive optical element of the present invention;

FIG. 20 is a view showing one example of the arrangement of the photo acceptance cells corresponding to the areas of the diffractive optical element of the present invention;

FIG. 21 is a block diagram showing another example of the arithmetic circuit of signal outputs of the photo acceptance cell of the present invention; and

FIG. 22 is a view showing a spread of the crosstalk lights on the photo acceptance cells in FIG. 20.

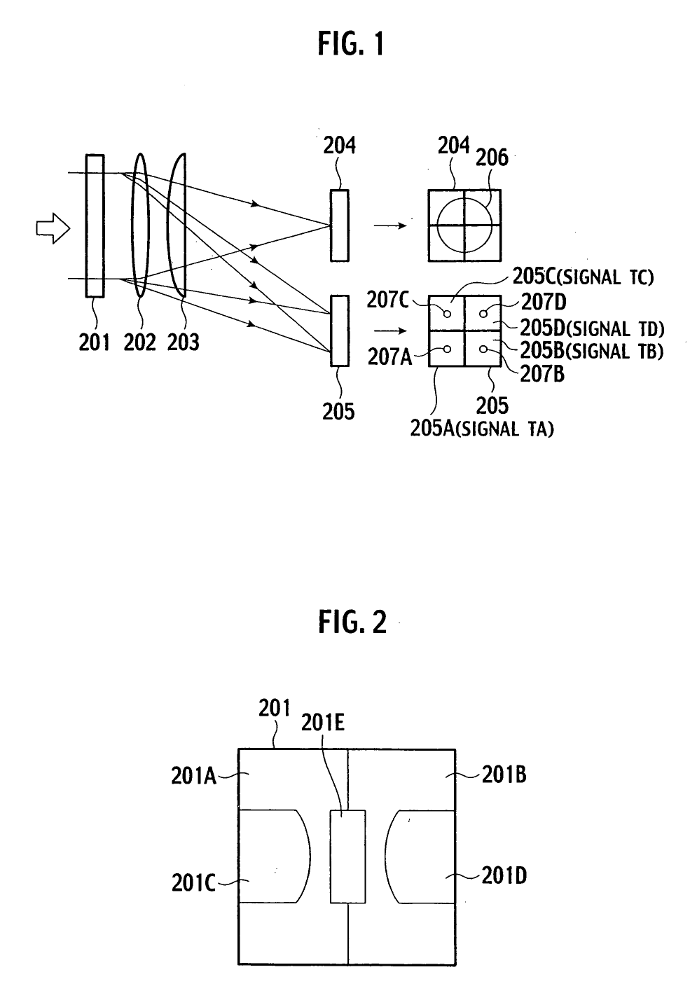

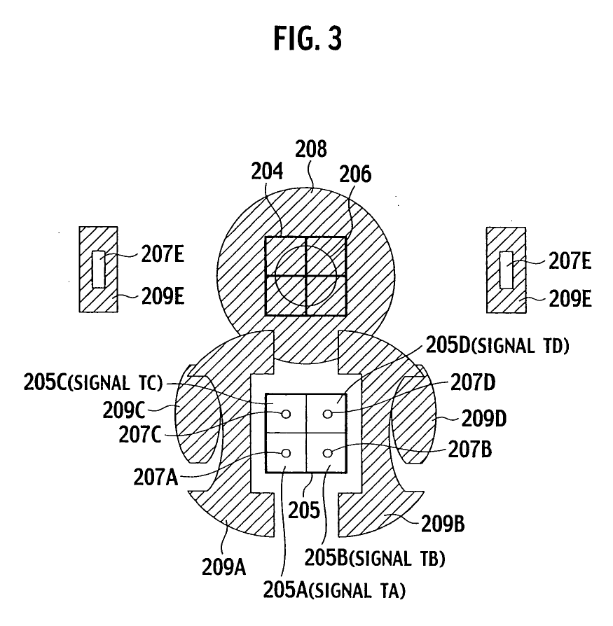

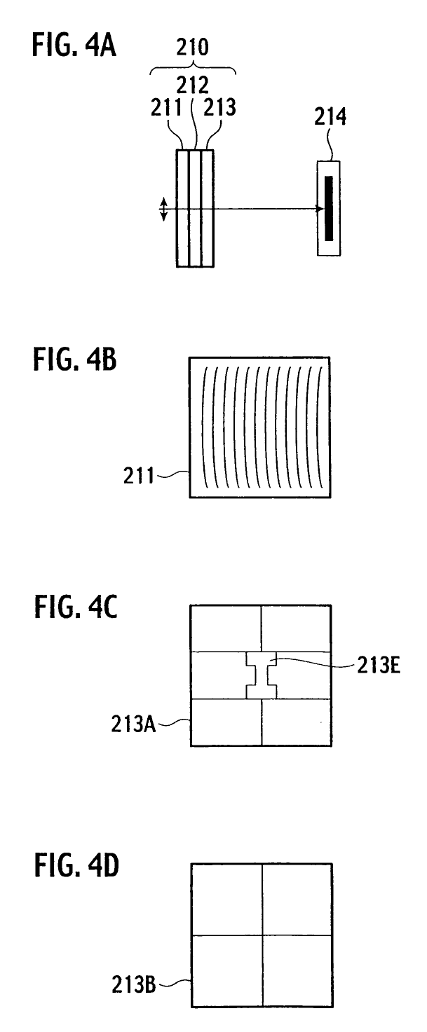

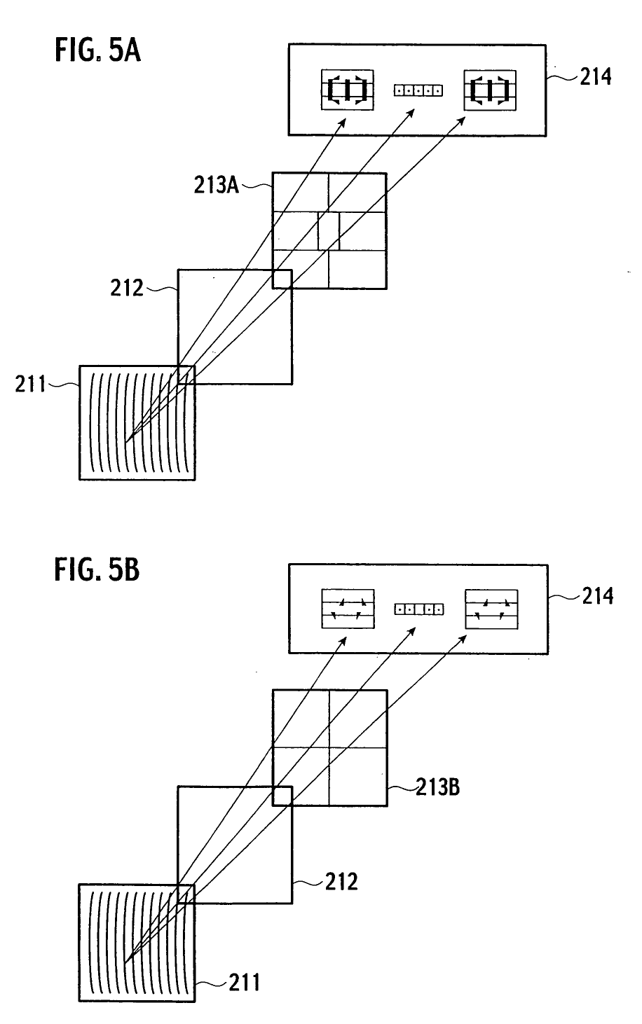

### DETAILED DESCRIPTION OF THE PREFERRED EMBODIMENT

### 1st. Embodiment

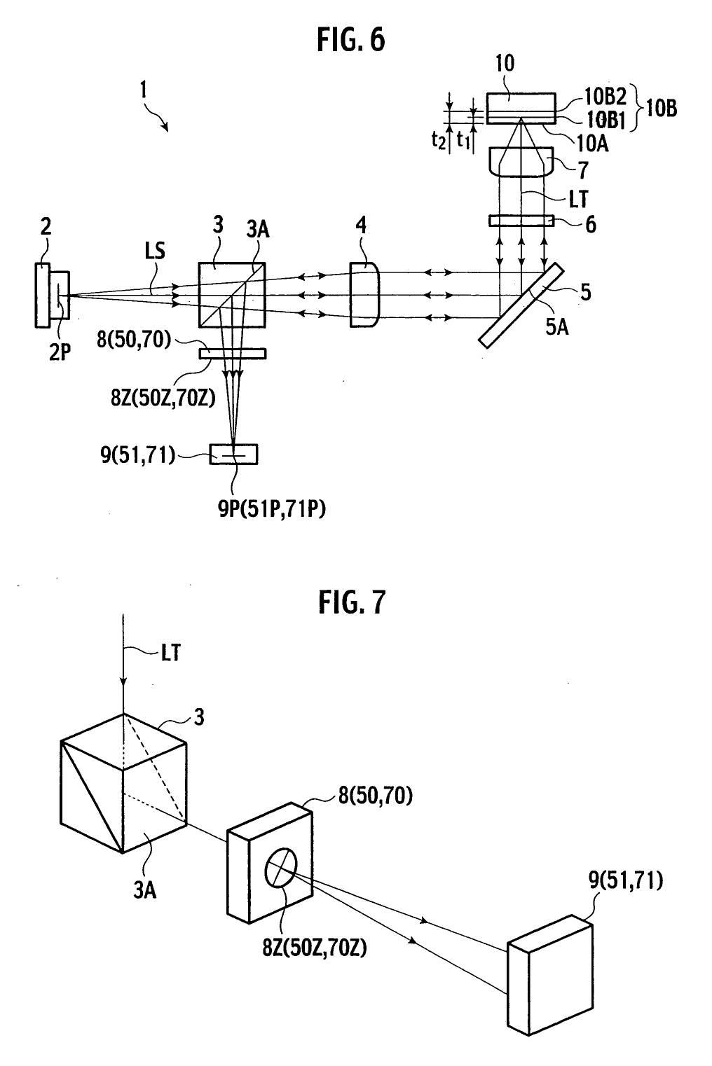

The first embodiments of the present invention will be described with reference to FIGS. 6 to 12. FIG. 6 is a view showing one example of an overall structure of an optical pickup device of the present invention. The optical pickup device 1 is a device that records information on an optical disc (BD) 10 under the Blu-ray standard having a double layer signal surface 10B by laser beam LS each having a wavelength λ=405 nm emitted from a laser source 2 or reproduces the information out of the optical disc 10. The optical disc 10 has a thickness t1=0.075 mm from an incident surface 10A to a first signal face, and a thickness t2=0.1 mm from the incident surface 10A to a second signal face.

An objective lens 7 is designed so as to optimally converge the laser beams at a position corresponding to a middle thickness between the first signal face and the second signal face, i.e. 0.0875 mm. The appropriate recording or reproducing of information about a first signal face 10B1 can be accomplished by shifting a collimator lens 4 in the direction of an optical path to make a slightly convergent light emitted from the collimator lens 4. Further, the appropriate recording or reproducing of information about a second signal face 10B2 can be accomplished by shifting the collimator lens 4 in the direction of the optical path to make a slightly divergent light emitted from the collimator lens 4. We now describe the embodiment on the assumption that the first signal face 10B1 is provided for a recording-reproducing layer, while the second signal face 10B2 is provided for other layer.

The laser beams LS emitted from an emission point 2P of the laser source 2, which are of linear p-polarized lights, are transmissible through an optical-path separator element 3. The optical-path separator element 3, which may be a polarizing beam splitter, a half mirror or the like, has only to separate one light directing from the laser source 2 to the optical disc 10 from the other light directing from the optical disc 10 to a photodetector 9. The element may be either square or flat. Assume, the optical-path separator element 3 is a polarizing beam splitter.

The light incident on the polarizing beam splitter 3 is transmitted through a polarization-dependent dielectric multilayer film 3A allowing a transmission of p-polarized light while reflecting s-polarized light. Thereafter, the light becomes a slightly-convergent light by the collimator lens 4. In succession, the slightly-convergent light is deflected by a reflection film 5A of a flat mirror 5 at an angle of 90 degrees and further supplied with a phase-contrast λ/4 by a quarter-wave plate 6, forming a circular light incident on an objective lens 7. Focused beams via the objective lens 7 enter the optical disc 10 through the incident surface 10A and further converge on the signal face 10B1 of the recording-reproducing layer, with improved aberration. In this way, the recording or reproducing operation is carried out.

Reflection light LT reflected on the signal face 10B1 of the recording-reproducing layer enters the objective lens 7 again to become a slightly-divergent light. The slightly-divergent light is further supplied with a phase-contrast λ/4 by the quarter-wave plate 6, forming a linear s-polarized light. Then, the linear s-polarized light is deflected by the reflection film 5A of the flat mirror 5 at an angle of 90 degrees. Thereafter, the deflected light becomes a convergent light by the collimator lens 4. The convergent light enters the polarizing beam splitter 3.

FIG. 7 is a view showing details of a detection system of the optical pickup device by way of example. As shown in FIG. 7, the reflection light LT of s-polarized light incident on the polarizing beam splitter 3 is reflected on the polarization-dependent dielectric multilayer film 3A. Then, the so-reflected light LT is divided through respective areas of an element face 8Z of a spatial divide element 8 and simultaneously supplied with astigmatism. Means for applying astigmatism may be provided by either respective areas of the element face 8A or cylindrical lenses etc. Suppose, in the first embodiment, the astigmatism is applied to the light at the respective areas of the element face 8A. The light supplied with astigmatism is received by photo acceptance cells on an acceptance surface of the photodetector 9, in the form of respective spots of the signal detection light. Subsequently, the spots are photo-electrically transferred to respective electrical signals. For each electrical signal, tracking-error signal, focussing-error signal and main-data signal are calculated in accordance with predetermined computing equations mentioned later.

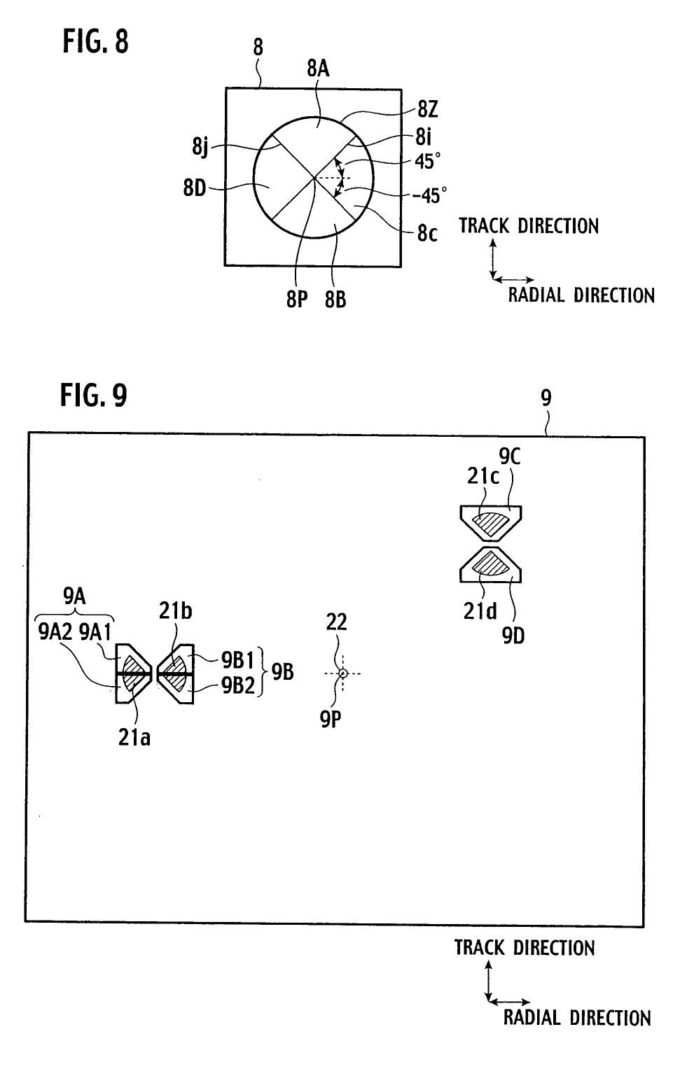

Referring to FIGS. 8 and 9, we now explain the detection system of the optical pickup device 1, which is essential to the present invention. FIG. 8 shows one example of the areas of the element face of the spatial divide element. FIG. 9 shows one arrangement of the photo acceptance cells of the photodetector by way of example.

In FIG. 8, the reflection light LT reflected by the polarizing beam splitter 3 and further incident on the spatial divide element 8 is spatially divided by hologram patterns consisting of four areas 8A to 8D in the element face 8Z of the spatial divide element 8 and additionally subjected to deflection.

As shown in FIG. 8, two parting lines 8i, 8j running on a center 8P of the optical axis divide the element face into four areas 8A to 8D. The two parting lines 8i, 8j are arranged at angles of ±45 degrees to a direction (referred to as “radial direction” after.) perpendicular to the direction of a track of the optical disc 10 while being projected on the element face 8Z. Thus, the areas 8A to 8D are provided with different hologram patterns every area and also constructed so as to apply the astigmatism to the light transmitted therethrough. In this way, there are produced four first order diffraction lights supplied with the astigmatism, corresponding to the four areas 8A to 8D. Note, if the objective lens 7 is subjected to neither lens-shifting nor lens-tilting, then the flux center of the reflection light from the signal face 10B1 of the recording-reproducing layer substantially passes through the axis center 8P in the element face 8Z of the spatial divide element 8.

Thereafter, the four first order diffraction lights are received by photo acceptance cells 9A to 9D on the acceptance surface of the photodetector 9 of FIG. 9 while forming spots 21a to 21d of the signal detection light. The photo acceptance cells 9A to 9D are arranged so as to cope with respective diffracting directions of the areas 8A to 8D in the element face 8Z of the spatial divide element 8. Thus, the first order diffraction light diffracted by the area 8A is received by the photo acceptance cell 9A (straddling over cells 9A1, 9A2) to form the spot 21a of the signal detection light. Similarly, the first order diffraction light diffracted by the area 8B is received by the photo acceptance cell 9B (straddling over cell parts 9B1, 9B2) to form the spot 21b, the first order diffraction light diffracted by the area 8C being received by the photo acceptance cell 9C to form the spot 21c, and the first order diffraction light diffracted by the area 8D is received by the photo acceptance cell 9D to form the spot 21d. On condition that the track of the optical disc 10 is projected on the acceptance surface of the photodetector 9, the photo acceptance cell 9A is divided into the photo acceptance cells 9A1 and 9A2. Similarly, the photo acceptance cell 9B is divided into photo acceptance cells 9B1 and 9B2. The axis center 8P of the element face 8Z of the spatial divide element 8 substantially coincides with a center 9P on the acceptance surface of the photodetector 9 in the direction of the optical axis.

On the photo acceptance cells 9A to 9D, the spots 21a to 21d of the signal detection lights are fan-shaped corresponding to profiles of the areas 8A to 8D. However, if the spatial divide element is provided with no area to produce a circular hologram pattern and a circular spot forming a circle of least confusion, then the resulting diffraction light would not produce other aberration but an appropriate astigmatism. Then, the photo acceptance cells 9A to 9D are arranged in positions where each spot of respective signal detection lights becomes a circle of least confusion at the substantial midpoint between two focal lines due to the astigmatism. In the areas 8A to 8D, alternatively, their hologram patterns may be provided with the function of cylindrical lenses and further lens power different from each other. Because, respective distances from the areas 8A to 8D of the spatial divide element 8 of FIG. 8 to the corresponding photo acceptance cells 9A to 9D of FIG. 9 are different from each other. Therefore, if there is no difference in the lens power among the areas, respective diameters of spots formed on the photo acceptance cells 9A to 9D would differ from each other.

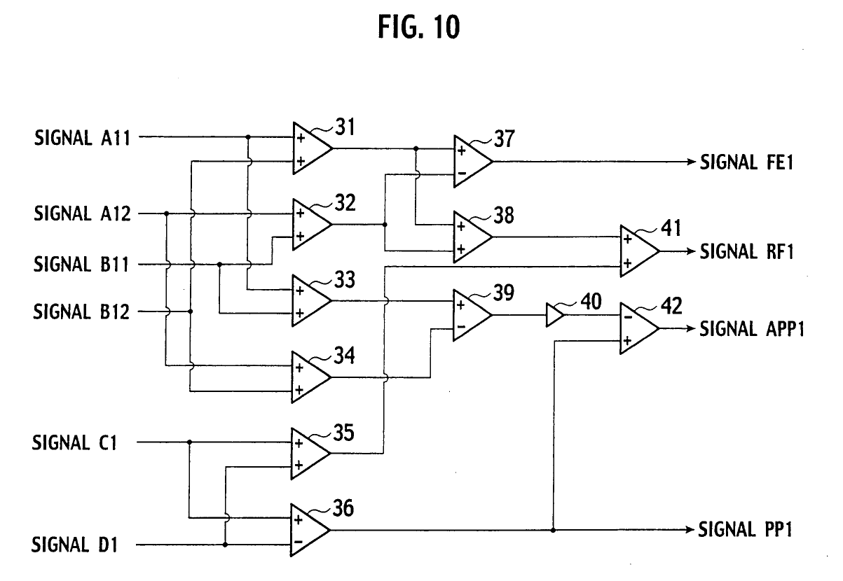

FIG. 10 is a block diagram showing an arithmetic circuit of signal outputs of the photo acceptance cell by way of example. This circuit calculates a focussing-error signal FE1, tracking-error signals PP1, APP1 and a main signal RF1. In FIG. 10, a method of calculating the focussing-error signal FE1 will be described at first.

Using an electrical signal A11 from the photo acceptance cell 9A1, an electrical signal A12 from the photo acceptance cell 9A2, an electrical signal B11 from the photo acceptance cell 9B1, an electrical signal B12 from the photo acceptance cell 9B2, adders 31, 32 and a subtracter 37, the focussing-error signal is calculated by the following equation (2):

FE1=(A11+B12)−(A12+B11) (2).

As shown with the equation (2), as a general astigmatic method is available to detect a focussing error, the optical pickup device 1 is capable of dealing with conventional FEP easily.

The spot of the reflection light from the signal face 10B1 of the recording-reproducing layer contains an overlapping part between a first order light diffracted by a tracks or a pit (referred to as “track” after) and zero-order non-diffracted light. As the first parting line 8i and the second parting line 8j are arranged so that the spatial divide elements 8A, 8B do not include the overlapping part, a variance of light intensity due to track-crossing is hard to occur. Thus, the variance in the focussing-error signal is suppressed.

Next, a method of calculating the tracking-error signal PP1 will be described. An electrical signal C1 is picked up from the photo acceptance cell 9C, while an electrical signal D1 is picked up from the photo acceptance cell 9D. The electrical signals C1, D1 contain push-pull signal components. Thus, using the electrical signals C1, D1 and a subtracter 36, the tracking-error signal PP1 by a general PP (Push Pull) method is calculated by the following equation (3):

PP1=C1−D1 (3).

Meanwhile, the tracking-error signal by the general PP method or DPP method is known as a signal that produces offsetting when the lens is shifted or the optical disc is tilted in the radial direction. The above-mentioned APP method is known as a method of detecting a tracking error while reducing this offsetting. Using the electrical signals A11 to D1, the adders 33 and 34, the subtracters 36, 39 and 42 and a multiplier 40, a tracking-error signal APP1 by the APP method is calculated by the following equation (4):

APP1=(C1−D1)−k1·{(A11+B11)−(A12+B12)} (4),

where k1 is a multiplier coefficient of the multiplier 40.

This tracking-error signal APP1 is capable of reducing offsetting at reproducing a boundary between recording marks as well as the above-mentioned offsetting at shifting the lens etc. That is, by compensating the tracking-error signal by a DC component as a result of subtracting a sum (A12+B12) from a sum (A11+B11), it is possible to reduce an offsetting at reproducing the boundary between the recording marks. Note, the multiplier coefficient k1 is optimized so as to compensate an offset at a lens shift and the boundary between the recorded marks and also reduce the possibility of the offset in spite of disturbance. Fro above, the tracking-error signals PP1, APP1 can be obtained by using not three beams but one beam.

Using the electrical signals A11 to D1 and the adders 31, 32, 35, 38 and 41, a main signal RF1 is calculated by the following equation (5):

RF1=A11+A12+B11+B12+C1+D1 (5).

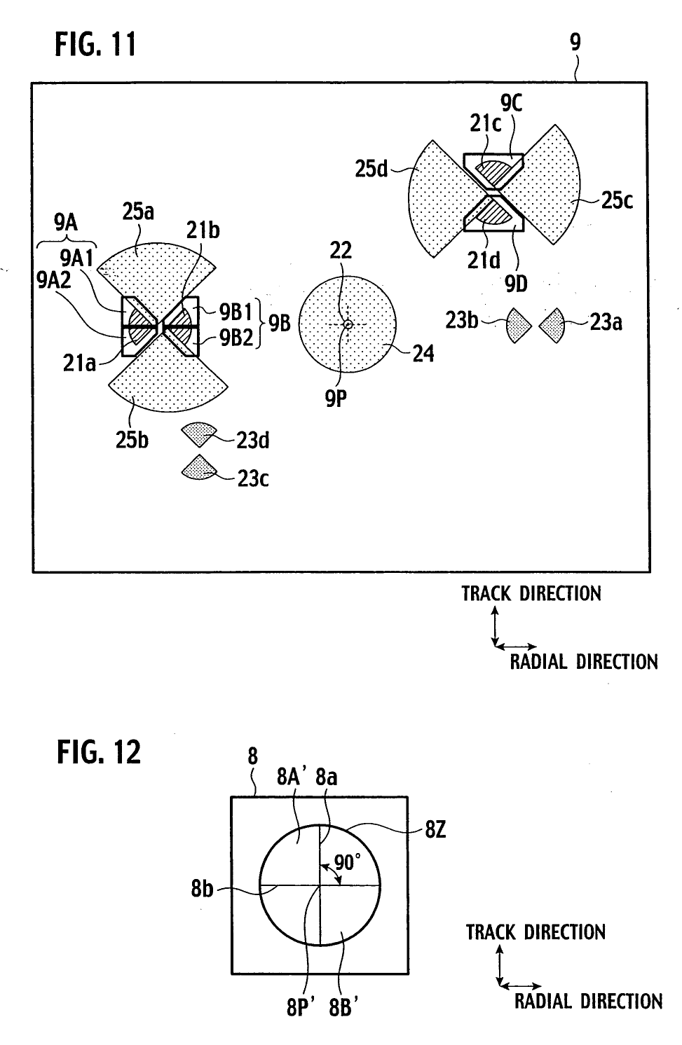

FIG. 11 is a view showing the state of crosstalk lights on the acceptance surface of the photodetector in FIG. 9 by way of example. The crosstalk lights comprises crosstalk lights reflected on the signal face 10B1 of the recording-reproducing layer and further diffracted by the element face 8Z of the spatial divide element 8 except the first order diffraction light, and other crosstalk lights reflected on the signal face 10B2 of the other layer and further diffracted by the element face 8Z of the spatial divide element 8.

First, we now consider the crosstalk lights produced by the signal face 10B1 of the recording-reproducing layer. In FIG. 11, the spots 21a to 21d of the signal detection light produced by the signal face 10B1 of the recording-reproducing layer converge to the photo acceptance cells 9A to 9D. A spot 22 of light reflected on the signal face 10B1 of the recording-reproducing layer but non-diffracted by the areas 8A to 8D of the element face 8Z of the spatial divide element 8 (i.e. spot of zero order diffraction light) converges onto the center 9P of the acceptance surface. If the photo acceptance cells 9A to 9D are somewhat away from the center 9P of the acceptance surface respectively, the spot 22 derived from the zero order diffraction light has no influence on signals.

Spots 23a to 23d of a minus (−) first-order diffraction light reflected on the signal face 10B1 of the recording-reproducing layer and diffracted by the areas 8A to 8D of the element face 8Z of the spatial divide element 8 appear in symmetrical positions to the spots 21a to 21d about the center 9P of the acceptance surface. Therefore, as shown in FIG. 11, it is possible to allow the spots 23a to 23d to be radiated out of the photo acceptance cells 9A to 9D. In addition, as spots of high order diffraction lights are generated far from the photo acceptance cells 9A to 9D, we have only to consider only the zero order diffraction light and the minus (−) first-order diffraction light as the diffraction lights.

Secondly, we consider the crosstalk lights produced by the signal face 10B2 of the other layer. As these crosstalk lights become more diffusible with magnifying power, the first order diffraction light exerts a main influence on them. Thus, we have only to consider the diffraction lights up to the zero order diffraction light. In FIG. 11, spots 25a to 25d of the first order diffraction light reflected on the other signal face 10B2 of the other layer and diffracted by the areas 8A to 8D of the element face 8Z of the spatial divide element 8 spread in the form of fans having the same center angles as those of the four areas 8A to 8D. As shown in FIG. 11, it is possible to allow the spots 25a to 25d not to be radiated on the photo acceptance cells 9A to 9D as much.

A spot 24 of zero order diffraction light reflected on the signal face 10B2 of the other layer but non-diffracted by the areas 8A to 8D of the element face 8Z of the spatial divide element 8 spreads on the acceptance surface while forming a circular spot having a larger diameter than the spot 22. Nevertheless, with an appropriate arrangement of the photo acceptance cells 9A to 9D in the track direction and the radial direction, it is possible to allow the spot 24 not to be radiated on the photo acceptances 9A to 9D.

As described above, according to this embodiment, the recording or reproducing of information with respect to the signal faces of the multilayer optical disc can be appropriately accomplished since the flux of reflection light reflected on the signal face 10B1 of the recording-reproducing layer and directed to the photodetector 9 is spatially divided and deflected by the spatial divide element 8 of FIG. 8 and subsequently, the fluxes transmitted through the respective areas 8A to 8D are provided with astigmatisms and further radiated on the photo acceptance cells 9A to 9D respectively.

Additionally, owing to the arrangements of the areas 8A to 8D and the photo acceptance cells 9A to 9D shown in FIGS. 8 and 9, it is possible to construct the optical pickup device so as not to radiate the crosstalk lights 22, 23a to 23d from the signal face 10B1 of the recording-reproducing layer and the crosstalk lights 24, 25a to 25d from the signal face 10B2 of the other layer onto the photo acceptance cells 9A to 9D. Thus, it is possible to stabilize the recording or reproducing of information with respect to the multilayer optical disc. Besides, although it is desirable that the spot 24 is not radiated on all the photo acceptance cells 9A to 9D, the stable recording or reproducing may be also realized in the opposite manner that a uniform offsetting is applied on all the photo acceptance cells 9A to 9D on condition that the spot 24 is radiated on all of them.

According to the first embodiment, as the number of photo acceptance cells is reduced in comparison with that of the optical pickup device disclosed in nonpatent document No. 2, it is possible to manufacture the optical pickup device 1 having its reduced circuit scale, at a lower cost. Additionally, as the adoption of one-beam type laser beam makes gratings indispensable, the optical pickup device of the embodiment has advantages of the possibility of coping with multiple kinds of optical discs of different track pitches, such as BD and HD-DVD, due to the absence of either adjustment of gratings or light-power loss therefrom.

Further, the optical pickup device may be modified so as to detect the focussing-error signal and the tracking-error signal by using not all of the areas but at least two areas. FIG. 12 is a view showing another example of constituent areas in the element face of the spatial divide element. As shown in FIG. 12, the element face is divided into four areas by a parting line 8a in the same direction as the track direction in case of projecting the tracks of the optical disc 10 and a parting line 8b in the radial direction intersecting with the parting line 8b at the axis center 8P′. Thus, the optical pickup device is adapted so as to use two diagonal areas 8A′ and 8B′ of the resulting areas.

Then, the areas 8A′ and 8B′ are formed with different hologram patterns and also adapted so as to apply an astigmatism to each flux passing therethrough. The flux of the reflection light reflected on the signal face 10B1 enters the spatial divide element 8. Then, by the areas 8A′ and 8B′ of the element 8, astigmatisms are applied to the flux to be two diffraction lights, which are emitted from the element 8 and subsequently converged onto the photo acceptance cells of the photodetector 9. In the flux of reflection light reflected on the signal face of the recording-reproducing layer, since an interference part where a zero order light in the flux and its first order light overlap each other enters both of the areas 8A′ and 8B′ of the spatial divide element, it becomes possible to calculate both the focussing error signal and the tracking error signal in the push-pull method.

From above, if only a spatial divide element is provided with two or more areas, then it is possible to calculate both the focussing error signal and the tracking error signal on receipt of the reflection light diffracted by the spatial divide element. In the spatial divide element, additionally, there is no need for its element face to have a function of diffraction.

### 2^{nd}. Embodiment

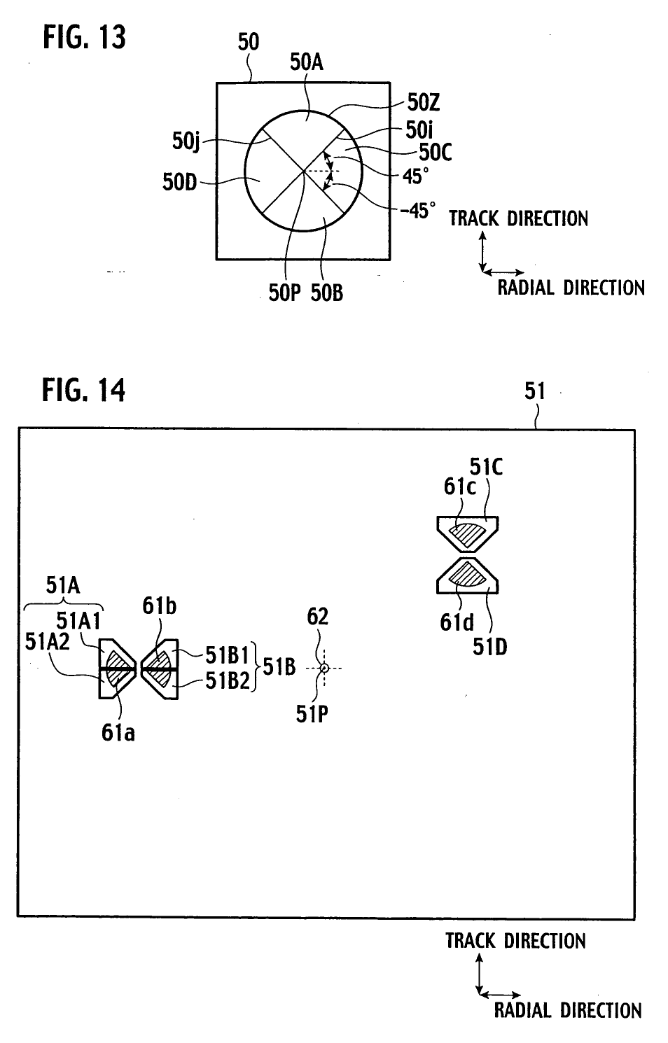

Referring to FIGS. 13 to 18, we now the second embodiment of the present invention, more particularly, its futures different from the first embodiment in detail. According to the second embodiment, the spatial divide element 8 and the photodetector 9 of the first embodiment are replaced with a diffractive optical element 50 and a photodetector 51, respectively (FIGS. 6 and 7). The other constituents are identical to those of the first embodiment as well as the arrangement of optical components and therefore, the descriptions about FIGS. 6 and 7 are eliminated.

FIG. 13 shows one example of the areas of a HOE face of the diffractive optical element. FIG. 14 shows another arrangement of the photo acceptance cells of the photodetector by way of example. As shown in FIG. 13, two parting lines 50i, 50j running on a center 50P of the optical axis divide the element into four areas 50A to 50D. In the four areas 50A to 50D, light as the signal detection light is diffracted to predetermined directions by a diffraction light having the order number ma, respectively. We explain the second embodiment on the assumption of setting 1 in the order number ma (ma=1) for diffraction of the signal detection light in the areas 50A to 50D, although the order number ma may be selected from any optional number but 0.

In FIG. 13, the two parting lines 50i, 50j are arranged at angles of ±45 degrees to a radial direction where the recording tracks of the optical disc 10 are projected on a HOE face 50Z. Thus, the areas 50A to 50D are structured so as to have hologram patterns of different diffraction structures and apply an astigmatism to the first order diffraction light (ma=1). Consequently, four first-order diffraction lights are produced with the astigmatisms, corresponding to the four areas 50A to 50D. Note, when the objective lens 7 is neither shifted nor tilted, a center of flux of the reflection light on the signal face 10B1 of the recording-reproducing layer substantially passes through the axis center 50P of the element face 50Z. The united areas 50A to 50D may be shaped to be either oval or polygonal, although the illustrated areas are circular-shaped in union.

Thereafter, the four first order diffraction lights are received by photo acceptance cells 51A to 51D on the acceptance surface of the photodetector 51 of FIG. 14 to form spots 61a to 61d of the signal detection light. The photo acceptance cells 51A to 51D are arranged corresponding to respective diffracting directions of the areas 50A to 50D of the HOE face 50Z. Thus, the first order diffraction light diffracted by the area 50A is received by the photo acceptance cell 51A (straddling over cells 51A1, 51A2) to form the spot 61a. Similarly, the first order diffraction light diffracted by the area 50B is received by the photo acceptance cell 51B (straddling over cell parts 51B1, 51B2) to form the spot 61b, the first order diffraction light diffracted by the area 50C being received by the photo acceptance cell 51C to form the spot 61c, and the first order diffraction light diffracted by the area 50D is received by the photo acceptance cell 51D to form the spot 61d.

The center 51P of the acceptance surface is a position where the zero order diffraction light reflected on the signal face 10B1 of the recording-reproducing layer and transmitted through the areas 50A to 50D without diffraction converges to form a spot 62. The optical axis center 50P of the HOE face 50Z substantially coincides with the center 51P of the acceptance surface in the direction of the optical axis. In the second embodiment, additionally, a distance from a midpoint between the photo acceptance cells 51A and 51B to the center 51P of the acceptance surface is generally equal to a distance from a midpoint between the photo acceptance cells 51C and 51D to the center 51P. The reason is that if the former distance is greatly different from the latter distance, respective diffraction pitches of the hologram patterns of the areas 50A to 50D would vary to cause a difference in the light power received by the photo acceptance cells 51A to 51D.

When projecting the tracks of the optical disc 10 on the acceptance surface of the photodetector 51, the photo acceptance cell 51A is divided into photo acceptance cells 51A1 and 51A2 in the radial direction. Similarly, the photo acceptance cell 51B is divided into photo acceptance cells 51B1 and 51B2 in the radial direction. The photo acceptance cells 51A, 51B have to be divided into two each in order to calculate a focusing error signal by means of an astigmatism method mentioned later. In general, the astigmatism is applied in the direction of 45 degrees. If the astigmatism in the direction of 45 degrees is applied in the areas 50A, 50B, respective spots at the circle of least confusion are rotated 90 degrees. Therefore, it is desirable that the photo acceptance cells 51A, 51B are divided in the radial direction.

The spots 61a to 61d of the signal detection lights are fan-shaped on the photo acceptance cells 51A to 51D corresponding to the areas 50A to 50D. However, if the diffractive optical element is provided with no area to produce a circular hologram pattern and a circular spot forming a circle of least confusion, then the resulting diffraction light does not produce other aberration but an appropriate astigmatism. Then, as each spot of respective signal detection lights becomes a circle of least confusion at the substantial midpoint between two focal lines due to the astigmatism, the photo acceptance cells 51A to 51D are arranged in the positions of respective midpoints.

Considering the adjustment of the optical pickup device 10 by servo signals, such as the focussing error signal and the tracking error signals, it is desirable that the astigmatisms applied in the areas 50A to 50D of the HOE face 50Z are in a similar direction and also a direction of 45 degrees throughout all the areas 50A to 50D.

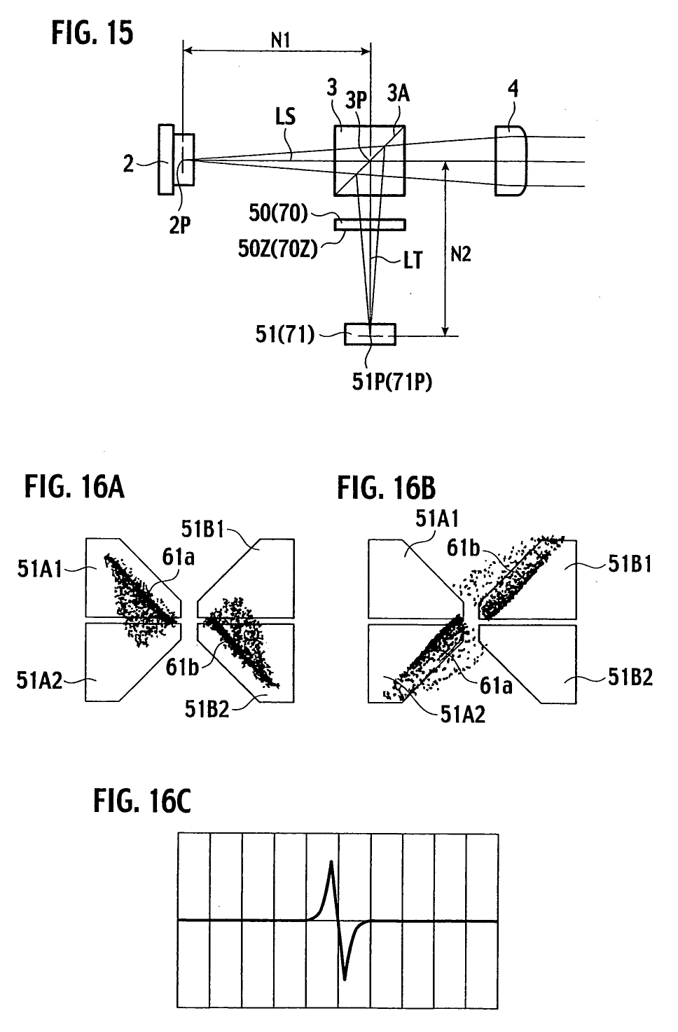

FIG. 15 is a view showing effective distances of the optical pickup device on both emission and detection sides. In FIG. 15, a center 3P of the polarizing beam splitter is an intersecting point of the optical axis with the polarization-dependent dielectric multilayer film 3A. In the figure, “N1” designates an effective distance from the emission point 2P of the laser source 2 to the center 3P of the polarizing beam splitter 3, while “N1” designates an effective distance from the center 3P of the polarizing beam splitter 3 to the center 51p of the acceptance surface of the photodetector 51. Note, the term “effective distance” means an air conversion length determined by a refractive index of a glass material. Then, if an effective distance from the collimator lens 4 to the emission point 2P of the laser source 2 is equal to an effective distance from the collimator lens 4 to the center 51P of the acceptance surface of the photodetector 51, in other words, if the effective distance N1 is equal to the effective distance N2, then the emission point 2P of the laser source 2 and the center 51P of the acceptance surface of the photodetector 51 are in a conjugated arrangement.

On the other hand, the distances from the center 51P of the acceptance surface to the photo acceptance cells 51A to 51D are all less than several hundred microns (μm). Therefore, the effective distance from the emission point 2P of the laser source 2 to the collimator 4 becomes substantially equal to the effective distances from the collimator 4 to the photo acceptance cells 51A to 51D of the photodetector 51. Thus, the areas 50A to 50D have minute lens power. The lens power is a power component corresponding to the lens effect. In the second embodiment, the lens power means a power of the diffraction surface. The smaller the power component gets in the areas 50A to 50D, the smaller the position error of the spots gets in comparison with the position error between the HOE face 50Z of the diffractive optical element 50 and the optical axis. The reason is that if the areas do not have lens power at all, the HOE face 50Z of the diffractive optical element 50 could be regarded as a flat plate having no hologram pattern.

As mentioned above, by positioning the emission point 2P of the laser source 2 and the center 51P of the acceptance surface of the photodetector 51 in the conjugated arrangement, the areas 50A to 50D do nothing but have minimum minute lens power. Therefore, it is possible to gain the focussing error signal and the tracking error signal both stable with improved S/N ratios.

FIGS. 16A to 16C are views showing an S-curve to gain the focussing error signal and spot profiles. FIG. 16A shows the profiles of spots on the photo acceptance cells 51A, 51B on condition that the S-curve is maximized since the optical disc 10 is close to the objective lens 7. Then, the photo acceptance cells 51A1 and 51B2 are subjected to radiations of much spots 61a, 61b constituting the majority of a signal detection light, while the photo acceptance cells 51A2 and 51B2 are subjected to only radiations of small number of spots 61a, 61b. FIG. 16B shows the profiles of spots on the photo acceptance cells 51A, 51B on condition that the S-curve is minimized since the optical disc 10 is far from the objective lens 7. Then, the photo acceptance cells 51A2 and 51B1 are subjected to radiations of much spots 61a, 61b, while the photo acceptance cells 51A1 and 51B2 are subjected to only radiations of small number of spots 61a, 61b. Accordingly, by calculating the focussing error signal FE2 while changing a focus, there can be obtained appropriate S-curve characteristics, as shown in FIG. 16C. In FIG. 16C, a horizontal axis represents a defocus amount (one graded scale=4 μm), while a vertical axis represents a level of the focussing error signal FE2. In FIG. 16C, the focussing error signal FE2 at a maximum corresponds to the state of FIG. 16A, while the focussing error signal FE2 at a minimum corresponds to the state of FIG. 16B. Note, if the defocus is not present at all, there are formed equable fan-shaped spots 61a, 61b on the photo acceptance cells.

Similarly to the first embodiment, it is assumed that “A11” represents an electrical signal obtained from the photo acceptance cells 9A1, “A12” an electrical signal from the photo acceptance cell 9A2, “B11” an electrical signal from the photo acceptance cell 9B1, “B12” an electrical signal from the photo acceptance cell 9B2, “C1” an electrical signal from the photo acceptance cell 9C, and “D1” represents an electrical signal obtained from the photo acceptance cell 9D. Then, the focussing error signal FE2 of the second embodiment is identical to the focussing error signal FE1 in the equation (2) of the first embodiment. In the second embodiment, similarly, a tracking error signal PP2, a tracking error signal APP2 and a main signal RF2 are identical to the tracking error signal PP1 in the equation (3) of the first embodiment, the tracking error signal APP1 in the equation (4) of the first embodiment and the main signal RF1 in the equation (5) of the first embodiment, respectively.

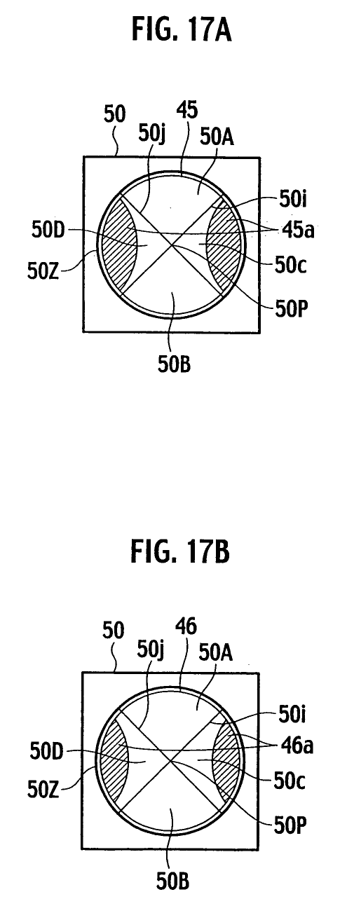

FIGS. 17A and 17B are views showing spot profiles on the HOE face of the diffractive optical element, including overlapping parts between the zero order light and the first order light both diffracted by the tracks. FIG. 17A shows a situation of recording or reproducing for BD, while FIG. 17B shows a situation of recording or reproducing for HD-DVD. In the spots 45, 46 of the lights reflected on the signal face 10B1 of the recording-reproducing layer, there are produced overlapping parts 45a, 46a of the first order lights diffracted by the tracks with the zero order lights non-diffracted by the tracks. When the overlapping parts 45a, 46a interfere with each other, there is produced a difference in the optical power between left and right, so that so-called “push-pull” signal components can be gained.

As the size of the overlapping parts 45a, 46a depends on the specification of an optical disc, there is a difference in the proportion of the overlapping parts 45a, 46a in between BD and HD-DVD. The overlapping proportion between the zero order diffraction light and the first order diffraction light is uniquely determined by the numerical aperture of the objective lens 7, a wavelength of the laser beam LS and a pitch of the tracks on the signal face 10B1 of the recording-reproducing layer.

In FIGS. 17A and 17B, when dividing the HOE face 50Z by the parting lines 50i, 50j (intersecting at an angle of ±45 degrees to the radial direction), they only have a room of about 7% for the radius of the spot 45 in case of BD and a room of about 14% for the radius if the spot 46 in case of HD-DVD. Assume here, for BD, the wavelength of 405 nm, the track pitch of 0.32 μm and the numerical aperture of 0.85; and for HD-DVD, the wavelength of 405 nm, the track pitch of 0.4 μm and the numerical aperture of 0.65.

With the parting lines 50i, 50j in FIGS. 17A and 17B, there is no possibility that the overlapping parts 45a, 46a are radiated on the areas 50A, 50B to be used in calculating the focussing error signal FE2. Thus, as the change in light intensity is hard to occur when crossing over the tracks, a variance of the focussing error signal is not produced by crossing over the tracks. Rather, as the overlapping parts 45a, 46a are not included more than requires, it is possible to exclude the influence of diffraction light whose cycle is twice as much as the track pitch, from the focussing error signal FE2. In case of BD, if the angle of the parting line 50i with the radial direction is less than 41.8 degrees, the overlapping parts 45a, 46a intersect with the parting line 50i. As well, if the angle of the parting line 50j with the radial direction is more than −41.8 degrees, the overlapping parts 45a, 46a intersect with the parting line 50j.

In case of HD-DVD if the angle of the parting line 50i with the radial direction is less than 39.7 degrees, the overlapping parts 45a, 46a intersect with the parting line 50i. As well, if the angle of the parting line 50j with the radial direction is more than −39.7 degrees, the overlapping parts 45a, 46a intersect with the parting line 50j. Slight intersection of the parting lines 50i, 50j with the areas 50A, 50B would have less effect on the calculation. Additionally, it is not preferable that there are excessively included an area where the zero order light and the first order light do not overlap each other. Considering these conditions, it is desirable that the angle between the parting line 50i and the radial direction is set more than 40 degrees and less than 50 degrees and that the angle between the parting line 50j and the radial direction is set more than −50 degrees and less than −40 degrees. As shown in FIGS. 17A and 17B, most preferably, the angle between the parting line 50i and the radial direction is set to 45 degrees, while the angle between the parting line 50j and the radial direction is set to −45 degrees.

Next, the crosstalk lights on the acceptance surface of the photodetector 51 will be described below. The crosstalk lights comprise the crosstalk lights reflected on the signal face 10B1 of the recording-reproducing layer and subsequently diffracted with the exception of the order number ma (=1) of the signal detection light and the crosstalk lights reflected on the signal face 10B2 of the other layer and subsequently diffracted with the order number ma by the HOE face 50Z.

Although it is desirable that the first order diffraction light to be diffracted in the areas 50A to 50D is more than 70%, it is unavoidable that the diffraction light with the exception of the order number ma=1 is produced with slight diffraction efficiency. As for the diffraction light having an optional order number ma, the larger the value of ma gets, the further a spot is formed apart from the photo acceptance cells 51A to 51D. Similarly to the first embodiment, therefore, we have only to consider both cases of ma=0 and ma=−1 in the order number, as the crosstalk lights reflected on the signal face 10B1 of the recording-reproducing layer and subsequently diffracted with the exception of the order number ma (=1) of the signal detection light by the HOE face 50Z.

While, the crosstalk lights reflected on the signal face 10B2 of the other layer and diffracted by the HOE face 50Z with the optional order number ma of the signal detection light are apt to spread as the magnifying power, so that its intensity of local light is small. Therefore, we consider such a situation of the order number ma=1 equal to that of the signal detection light exhibiting high diffraction efficiency.

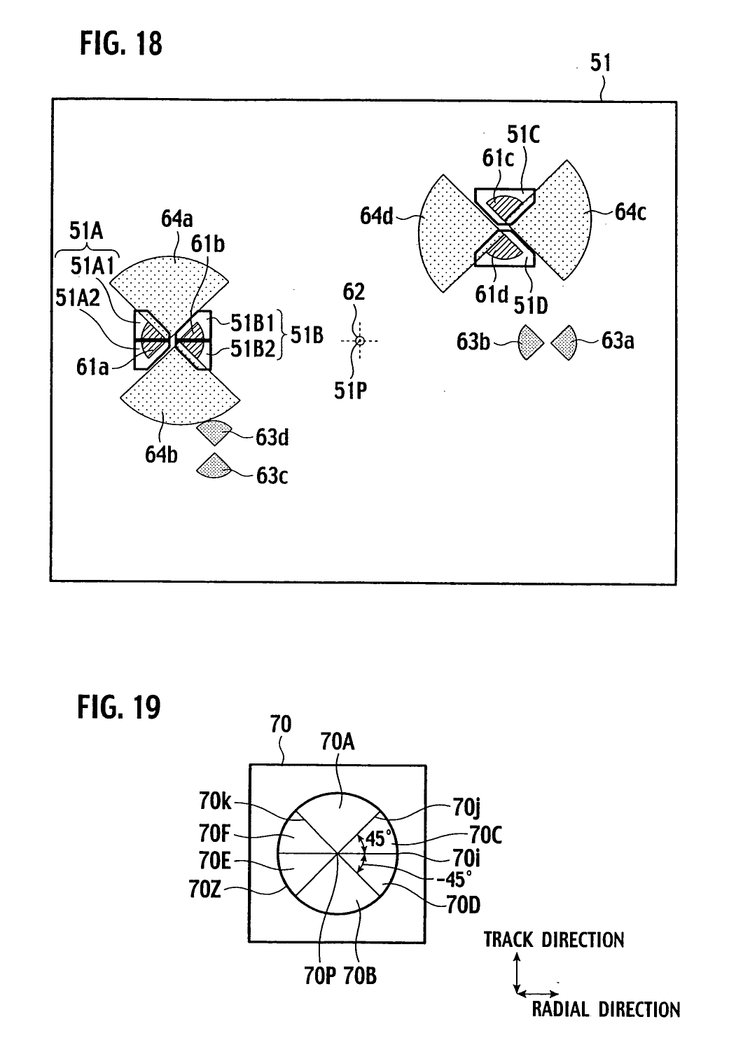

FIG. 18 shows one example of the crosstalk lights on the acceptance surface of the photodetector in FIG. 14. The spots 61a to 61d and 62 derived from the signal face 10B1 of the recording-reproducing layer have been described with reference to FIG. 14. Spots 63a to 63d reflected on the signal face 1013 of the recording-reproducing layer and further diffracted with the order number ma=−1 by the areas 50A to 50D of the HOE face 50Z are formed in symmetrical with the spots 61a to 61d about the center 51P of the acceptance surface. Thus, it is possible to arrange the spots 63a to 63d so as not to be radiated on the photo acceptance cells 51A to 51D. Consequently, the stable signals can be gained with improved S/N ratio.

Spots 64a to 64d reflected on the signal face 10B2 of the other layer and diffracted with the order number ma=1 by the areas 50A to 50D of the HOE face 50Z spread in the form of fans in the directions rotated at an angle of 90 degrees with the spots 61a to 61d. Thus, it is possible to allow the spots 64a to 64d to be hardly radiated on the photo acceptance cells 51A to 51D. Therefore, the stable signals can be gained with further improved S/N ratio.

As mentioned above, with the establishment of the conjugated arrangement between the emission point 2P of the laser source 2 and the center 51P of the acceptance surface, the optical pickup device is constructed so as to minimize the position error of the spots in spite of the presence of a position error of the diffractive optical element 50. Therefore, it is possible to gain the focussing error signal and the tracking error signal both stable with improved S/N ratios. Additionally, owing to the conjugated arrangement between the emission point 2P of the laser source 2 and the center 51P of the acceptance surface of the photodetector 51, the positioning of both the emission point 2P and the center 51P can be realized with ease. According to the second embodiment, with the adoption of a piece of diffractive optical element 50, it is possible to manufacture an optical pickup device at a low cost.

### 3^{rd}. Embodiment

Referring to FIGS. 19 to 22, the third embodiment of the present invention, more particularly, its futures different from the first and the second embodiments will be described in detail. According to the third embodiment, the diffractive optical element 50 and the photodetector 51 of the second embodiment are replaced with a diffractive optical element 70 and a photodetector 71, respectively (FIGS. 6 and 7). The other constituents are identical to those of FIGS. 6 and 7 as well as the arrangement of optical components.

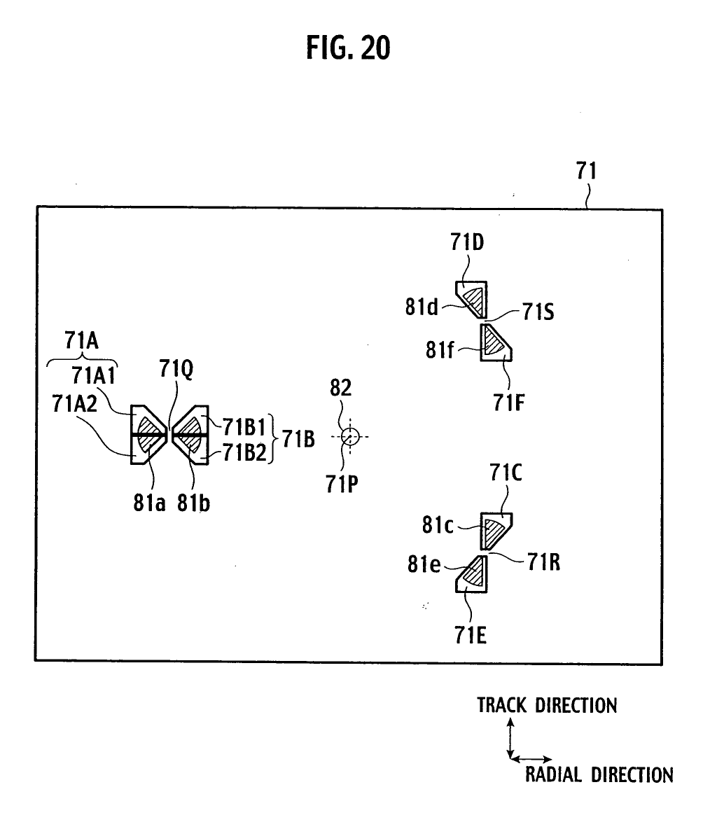

FIG. 19 shows another example of the areas of a HOE face of the diffractive optical element. FIG. 20 shows the other arrangement of the photo acceptance cells of the photodetector by way of example. As shown in FIG. 19, three parting lines 70i to 70k running on a center 70P of the optical axis divide the element into six areas 70A to 70F. In the six areas 70A to 70F, light as the signal detection light is diffracted to predetermined directions by a diffraction light having the order number ma, respectively. We explain the third embodiment on the assumption of setting 1 in the order number ma (ma=1) for diffraction of the signal detection light in the areas 70A to 70F, although the order number ma may be selected from any optional number but zero.

The six areas 70A to 70F of the HOE face 70Z are defined by three parting lines 70i, 70j and 70k running on the center 70P of the optical axis. Assume, the parting line 70i, the parting line 70j and the parting line 70k are referred to as “first parting line”, “second parting line” and “third parting line”, respectively. Then, the area 70A and the area 70B together defined between the second parting line 70j and the third parting line 70k will be referred to as “first area” and “second area”, respectively. Similarly, the area 70C and the area 70E together defined between the first parting line 70i and the third parting line 70j will be referred to as “third area” and “fourth area”, respectively. Between the first parting line 70i and the third parting line 70k, one area adjoining the area 70C_and another area adjoining the area 70E will be referred to as “area 70D” and “area 70F” after.

The first parting line 70i extends in the same direction as the radial direction. The second parting line 70j and the third parting line 70k are arranged at angles of 45 degrees to the first parting line 70i. Thus, the areas 70A to 70F are structured so as to have hologram patterns of different diffraction structures and apply astigmatisms to the first order diffraction light (ma=1). Consequently, six first-order diffraction lights are produced with astigmatisms corresponding to the six areas 70A to 70F. Similarly to the first and the second embodiments, when the objective lens 7 is neither shifted nor tilted, a center of flux of the reflection light on the signal face 10B1 of the recording-reproducing layer substantially passes through the axis center 70P of the HOE face 70Z.

Thereafter, the six first order diffraction lights are received by photo acceptance cells 71A to 71F on the acceptance surface of the photodetector 71 to form spots 81a to 81f of the signal detection light. The photo acceptance cells 71A to 71F are arranged corresponding to respective diffracting directions of the areas 70A to 70F of the HOE face 70Z. Thus, the first order diffraction light diffracted by the area 70A is received by the photo acceptance cell 71A (straddling over cells 71A1, 71A2) to form the spot 81a. Similarly, the first order diffraction light diffracted by the area 70B is received by the photo acceptance cell 71B (straddling over cell parts 71B1, 71B2) to form the spot 81b, the first order diffraction light diffracted by the area 70C being received by the photo acceptance cell 71C to form the spot 81c, the first order diffraction light diffracted by the area 70D being received by the photo acceptance cell 71D to form the spot 81d, the first order diffraction light diffracted by the area 70E being received by the photo acceptance cell 71E to form the spot 81e, and the first order diffraction light diffracted by the area 70F is received by the photo acceptance cell 71F to form the spot 81f.

The center 71P of the acceptance surface is a position where the zero order diffraction light reflected on the signal face 10B1 of the recording-reproducing layer and transmitted through the areas 71A to 71F without diffraction converges to form a spot 82. The center of flux of the reflection light on the signal face 10B1 of the recording-reproducing layer substantially passes through the optical axis center 70P of the HOE face 70Z. For the same reason as the first embodiment, a distance from a midpoint 71Q between the photo acceptance cells 71A and 71B to the center 71P of the acceptance surface, a distance from a midpoint 71R between the photo acceptance cells 71C and 71E to the center 71P and a distance from a midpoint 71S between the photo acceptance cells 71D and 71F to the center 71P are generally equal to each other.

When projecting the tracks of the optical disc 10 on the acceptance surface of the photodetector 71, the photo acceptance cell 71A is divided into photo acceptance cells 71A1 and 71A2 in the radial direction. Similarly, the photo acceptance cell 71B is divided into photo acceptance cells 71B1 and 71B2 in the radial direction. Also, the astigmatic directions are similar to those of the second embodiment.

On the photo acceptance cells 71A to 71F, the spots 81a to 81f of the signal detection lights are fan-shaped corresponding to the areas 70A to 70F. However, if the divide element is provided with no area to produce a circular hologram pattern and a circular spot forming a circle of least confusion, then the resulting diffraction light does not produce other aberration but an appropriate astigmatism. Then, as each spot of respective signal detection lights becomes a circle of least confusion at the substantial midpoint between two focal lines due to the astigmatism, the photo acceptance cells 71A to 71F are arranged in the positions of respective midpoints.

Also in the third embodiment similar to the second embodiment, the effective distance N1 on the emission side is equal to the effective distance N2 of the detection side, as shown in FIG. 15. Accordingly, the emission point 2P of the laser source 2 and the center 71P of the acceptance surface of the photodetector 71 are in a conjugated arrangement, so that the areas 70A to 70F do nothing but have minimum minute lens power. Therefore, as the optical pickup device 1 is constructed so as to allow the position error of the spots to be reduced in comparison with the position error of the diffractive optical element 70, it is possible to gain the focussing error signal and the tracking error signal both stable with improved S/N ratios.

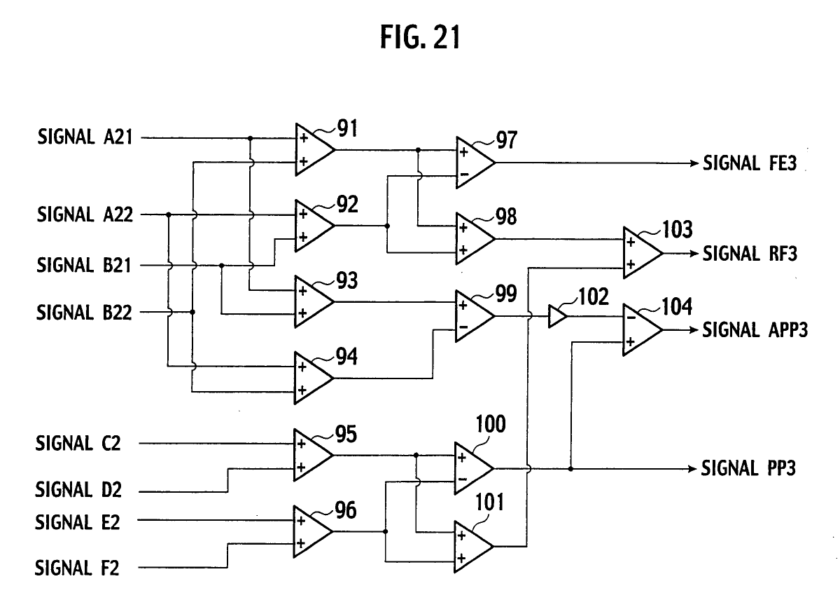

FIG. 21 is a block diagram showing an arithmetic circuit of signal outputs of the photo acceptance cell by way of example. This circuit calculates a focussing-error signal FE3, tracking-error signals PP3, APP3 and a main signal RF3. In FIG. 21, a method of calculating the focussing-error signal FE3 will be described at first. Using an electrical signal A21 from the photo acceptance cell 71A1, an electrical signal A22 from the photo acceptance cell 71A2, an electrical signal B21 from the photo acceptance cell 71B1, an electrical signal B22 from the photo acceptance cell 71B2, adders 91, 92 and a subtracter 97, the focussing-error signal is calculated by the following equation (6):

FE2=(A21+B22)−(A22+B21) (6).

As shown with the equation (6), as the general astigmatic method is available to detect a focussing error, the optical pickup device 1 is capable of dealing with conventional FEP easily.

Similarly to the second embodiment shown in FIGS. 17A and 17B, as the spots of the lights reflected on the signal face 10B1 of the recording-reproducing layer include overlapping parts between the zero order diffraction light and the first order diffraction light both diffracted by the tracks, push-pull signal components can be gained. Therefore, it is desirable to establish the angle of the first parting line 70i with the second parting line 70j more than 40 degrees and less than 50 degrees. As well, it is also desirable to set the angle between the first parting line 70i and the second parting line 70k more than −50 degrees and less than −40 degrees. It is most preferable to set the angle between the first parting line 70i and the second parting line 70i to 45 degrees and also set the angle between the first parting line 50i and the third parting line 70k to −45 degrees.

Next, a method of calculating the tracking-error signal will be described. An electrical signal C2 is picked up from the photo acceptance cell 71C, an electrical signal D2 from the photo acceptance cell 71D, an electrical signal E2 from the photo acceptance cell 71E, and an electrical signal F2 is picked up from the photo acceptance cell 71F. These electrical signals C2 to F2 contain push-pull signal components. Thus, using the electrical signals C2 to F2, adders 95, 96 and a subtracter 100, the tracking-error signal PP3 by the general PP method is calculated by the following equation (7):

PP3=(C2+D2)−(E2+F2) (7).

Additionally, using the electrical signals A21 to F2, adders 93, 94, 95 and 96, subtracters 99, 100 and 104 and a multiplier 102, the tracking-error signal APP3 is calculated by the following equation (8);

APP3=(C2+D2)−(E2+F2)−k2·{(A21+B21)−(A22+B22)}, (8)

where k2 is a multiplier coefficient of the multiplier 102. The multiplier coefficient k2 is optimized so as to compensate an offset at a lens shift and the boundary between the recording marks and the unrecorded marks and also reduce the possibility of the offset in spite of disturbance.

Using the electrical signals A21 to F2 and the adders 91, 92, 95, 96, 98, 101 and 103, a main signal RF3 is calculated by the following equation (9):

RF3=A21+A22+B21+B22+C2+D2+E2+F2 (9).

In case of the third embodiment, it is possible to detect the tracking error signal by the DPD method, which corresponds to a reproducing type optical disc, such as BD-ROM. A DPD signal is obtained by comparing a sum of the electrical signals C2 and E2 (=C2+E2) with a sum of the electrical signals D2 and F2 (=D2+F2) in calculation. Therefore, the optical pickup device of the third embodiment is constructed so as to be successful at both the APP method and the DPD method, allowing the matching for a wide variety of mediums in comparison with the first and the second embodiments.

Next, the crosstalk lights on the acceptance surface of the photodetector 71 will be described below. The crosstalk lights comprise the crosstalk lights reflected on the signal face 10B1 of the recording-reproducing layer and subsequently diffracted with the exception of the order number ma (=1) of the signal detection light by the HOE face 70Z and the crosstalk lights reflected on the signal face 10B2 of the other layer and subsequently diffracted with the order number ma by the HOE face 70Z. Similarly to the second embodiment, we have only to consider cases of ma=0, ma=−1 and additionally, mb=1 in the order number.

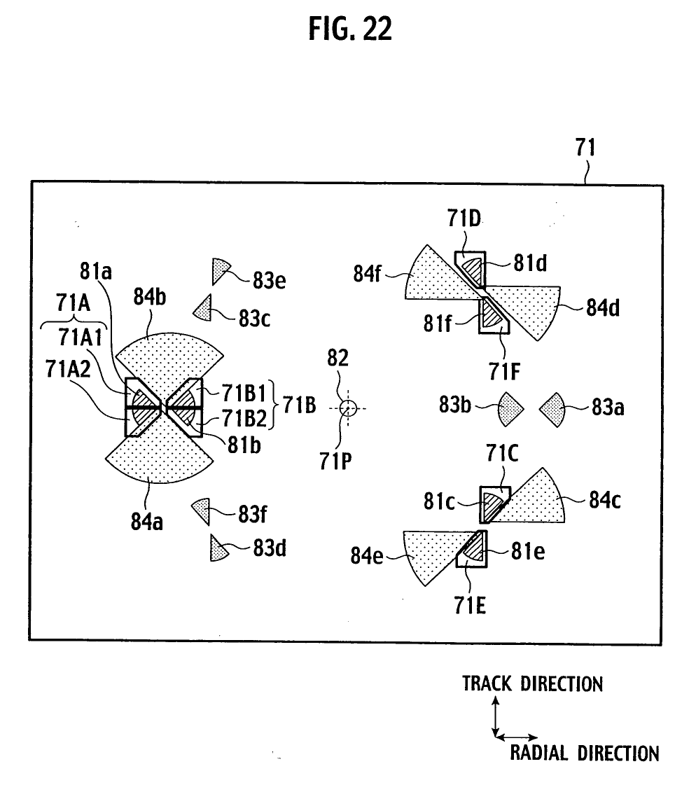

FIG. 22 shows spots formed by the crosstalk lights on the acceptance surface of the photodetector. The spots 81a to 81f and 82 derived from the signal face 10B1 of the recording-reproducing layer have been described with reference to FIG. 19. Spots 83a to 83f reflected on the signal face 10B1 of the recording-reproducing layer and further diffracted with the order number ma=−1 by the areas 70A to 70F of the HOE face 70Z are formed in symmetrical with the spots 81a to 81f about the center 71P of the acceptance surface. Thus, it is possible to arrange the spots 83a to 83f so as not to be radiated on the photo acceptance cells 71A to 71F. Consequently, the stable signals can be gained with improved S/N ratio.

Spots 84a to 84f reflected on the signal face 10B2 of the other layer and diffracted with the order number ma=1 by the areas 70A to 70F of the HOE face 70Z spread in the form of fans in the directions rotated at an angle of 90 degrees with the spots 81a to 81f. Thus, it is possible to allow the spots 84a to 84f to be hardly radiated on the photo acceptance cells 71A to 71F. Therefore, the stable signals can be gained with further improved S/N ratio.

As mentioned above, with the establishment of the conjugated arrangement between the emission point 2P of the laser source 2 and the center 71P of the acceptance surface, the optical pickup device 71 is constructed so as to minimize the position error of the spots in spite of the presence of a position error of the diffractive optical element. Therefore, it is possible to gain the focussing error signal and the tracking error signal both stable with improved S/N ratios. Additionally, owing to the conjugated arrangement between the emission point 2P of the laser source 2 and the center 71P of the acceptance surface of the photodetector 71, the positioning of both the emission point 2P and the center 71P can be realized with ease.

Additionally, as shown in FIG. 22, the optical pickup device is constructed so as not to radiate the crosstalk lights on all the photo acceptance cells. Therefore, it is possible to gain the focussing error signal and the tracking error signal both more stable with improved S/N ratios. In the third embodiment, with the adoption of a piece of diffractive optical element 70, it is possible to manufacture an optical pickup device at a low cost. Still further, it is possible to detect the tracking error signal by the DPD method, which corresponds to a reproducing type optical disc, such as BD-ROM.

Although the optical pickup device in common with the first to the third embodiments is constructed so as to deal with a single-sided double layer BD with use of a single blue laser source emitting a blue laser of 405 nm in wavelength, the present invention is not limited to the first to the third embodiments. For instance, by means of the same blue laser source, the invention is also applicable to an optical pickup device for both BD and HD-DVD, an optical pickup device for also dealing with DVD and CD and an optical pickup device for a triple layer optical disc, too.

As obvious from the above explanation, according to the present invention, as the tracking error signal can be gained by using one-beam type laser beam owing to the provision of the spatial divide element between the objective lens and the photodetector, there is no possibility of light-power loss by gratings and no need of adjusting the gratings, different from the three-beam type optical pickup device. Therefore, with the gain of signals having improved S/N ratios, the optical pickup device of the invention is capable of coping with even an optical disc having different track pitches and a different-type optical disc.

Further, according to the present invention, since respective areas of the spatial divide element are provided with lens effect, it is possible to produce the freedom of arranging the photo acceptance cells, allowing the optical pickup device to be small-sized at a low cost. According to the present invention, additionally, as the spatial divide element is formed by a single diffractive optical element, it is possible to generate signal with improved S/N ratios at a low cost without using any expensive component, such as liquid crystal element. Still further, according to the present invention, as the respective photo acceptance cells are not overlaid with the crosstalk lights, it is possible to gain signals having less noise and improved S/N ratios. Again, according to the present invention, with the possibility of realizing very little lens power against the diffractive optical element, the optical pickup device can be provided with a diffractive optical element resistant to its position error.

According to the present invention, owing to the provision of the diffractive optical element having six areas, which is positioned between the objective lens and the photodetector, and six areas corresponding to the areas respectively, it is possible to deal with a front end processor (FEP) adopting a conventional astigmatism method with ease, providing a structure generating signals with improved S/N ratios. Again, according to the present invention, due to the push pull method, it is possible to gain signals stable with improved S/N ratios.

In the preset invention, since the APP method is available to detect the tracking error signal, there is produced no offsetting in signals when reproducing a boundary between a recorded part and an unrecorded part on the signal face of an optical disc. Thus, it is possible to gain more stable tracking signals with improved S/N ratios. Further, according to the present invention, since an element's part through which an interference flux between zero order light and first order light produced at a result of the diffraction by the tracking grooves of a recording type optical disc and the pits of a reproducing type optical disc in the tracking direction is not used to calculate focussing error signals, it is possible to gain stable focussing error signals with improved S/N ratios.

What is claimed is:

1. An optical pickup device comprising:
a laser source for emitting laser beams;
a collimator lens for converting the laser beams emitted from an emission point of the laser source to substantially-parallel lights;
an objective lens that converges the substantially-parallel lights to form spots on a first signal face or a second signal face of an optical disc;
a spatial divide element having a plurality of parting lines arranged so as to run on a substantial flux center of a reflection light from the first signal face or the second signal face and a plurality of areas defined by the parting lines to thereby deflect the reflection light to predetermined directions respectively; and
a photodetector receiving signal detection lights diffracted in the predetermined directions and applied with astigmatisms by the areas of the spatial divide element and including a plurality of photo acceptance cells arranged in positions where the signal detection lights form a circle of least confusion at a substantial midpoint of two focal lines produced due to the astigmatisms, the photo acceptance cells corresponding to the plurality of areas respectively.

2. The optical pickup device of claim 1, wherein:
an optional area of the plurality of areas of the spatial divide element has a lens effect to thereby compensate a difference in respective distances between the respective areas and the respective photo acceptance cells and a difference between a magnification from the emission point of the laser source to the first signal face or the second signal face and a magnification from the first signal face or the second signal face to the photo acceptance cells.

3. The optical pickup device of claim 1, wherein the spatial divide element is formed by a diffractive optical element diffracting the reflection light to the predetermined directions.

4. The optical pickup device of claim 3, wherein:
all of the photo acceptance cells are arranged so as not to radiate crosstalk lights on the respective photo acceptance cells, and
the crosstalk lights comprise:
crosstalk lights reflected on one of the first signal face and the second signal face, which is included in a recorded or reproduced layer, and diffracted with the exception of an order number ma (ma: an integral number except 0) by the optional area of the diffractive optical element; and
a crosstalk light reflected on the other of the first signal face and the second signal face, which is included in a unrecorded or non-reproduced layer, and diffracted with the order number ma (ma: an integral number except 0) by the optional area of the diffractive optical element.

5. The optical pickup device of claim 3, assuming that a position on the photodetector where a zero-order diffraction light reflected on one of the first signal face and the second signal face, which is included in a recorded or reproduced layer, and transmitted through the diffractive optical element without diffractions by the plurality of areas does converge, is a center of an acceptance surface of the photodetector center, wherein:
an effective distance from the collimator lens to the emission point of the laser source is substantially equal to an effective distance from the collimator lens to the center of the acceptance surface.

6. The optical pickup device of claim 3, wherein:
the diffractive optical element is arranged so that when projecting a track of the optical disc, the first parting line is arranged in a direction perpendicular to a direction of the track, the second parting line is arranged in a direction making an angle more than 40 degrees and less than 50 degrees with the first parting line, and the third parting line is arranged in a direction making an angle more than −50 degrees and less than −40 degrees with the first parting line;
the diffractive optical element includes a first area and a second area both defined by the second parting line and the third parting line, a third area and a fourth area both defined by the first parting line and the second parting line, and a fifth area and a sixth area both defined by the first parting line and the third parting line; and
a first photo acceptance cell receiving a diffraction light diffracted by the first area and a second acceptance cell receiving a diffraction light diffracted by the second area are divided off by a parting line in a direction perpendicular to the direction of the track.

7. The optical pickup device of claim 6, wherein:
the third area adjoins the fifth area, while the fourth area adjoins the sixth area; and
by use of an output signal C of the photo acceptance cell receiving a diffraction light diffracted by the third area, an output signal E of the photo acceptance cell receiving a diffraction light diffracted by the fourth area, an output signal D of the photo acceptance cell receiving a diffraction light diffracted by the fifth area and an output signal F of the photo acceptance cell receiving a diffraction light diffracted by the sixth area, a tracking error signal PP is produced by the following equation (a):
PP=(C+D)−(E+F) (a).

8. The optical pickup device of claim 6, wherein:
the third area adjoins the fifth area, while the fourth area adjoins the sixth area; and
by use of an output signal C of the photo acceptance cell receiving a diffraction light diffracted by the third area, an output signal E of the photo acceptance cell receiving a diffraction light diffracted by the fourth area, an output signal D of the photo acceptance cell receiving a diffraction light diffracted by the fifth area, an output signal F of the photo acceptance cell receiving a diffraction light diffracted by the sixth area, output signals A1 and B1 from respective photo acceptance cells of the first and the second photo acceptance cells, the photo acceptance cells belonging to one side divided by the parting line perpendicular to the direction of the track, output signals A2 and B2 from respective photo acceptance cells belonging to the other side divided by the parting line perpendicular to the direction of the track and a constant k,
a tracking error signal APP is produced by the following equation (b):
APP=(C+D)−(E+F)−k{(A1+B1)−(A2+B2)} (b).

9. The optical pickup device of claim 6, wherein:
by use of output signals A1 and B1 from respective photo acceptance cells of the first and the second photo acceptance cells, the photo acceptance cells belonging to one identical side and output signals A2 and B2 from respective photo acceptance cells belonging to the other identical side,
a focussing error signal FE is produced by the following equation (c):
FE=(A1+B2)−(A2+B1)} (c).
